(19) United States
(12) Patent Application Publication
(10) Pub. No.: US 2017/0185900 A1
(43) Pub. Date: Jun. 29, 2017

(54) Reconstruction of signals using a Gramian Matrix

(71) Applicant: INTEL CORPORATION, Santa Clara, CA (US)

(72) Inventors: Arnab Paul, Hillsboro, OR (US); Nilesh Jain, Beaverton, OR (US); Hsiang-Tsung Kung, Cambridge, MA (US)

(73) Assignee: INTEL CORPORATION, Santa Clara, CA (US)

(21) Appl. No.: 14/998,235

(22) Filed: Dec. 26, 2015

(51) Int. Cl. G06N 5/02; G06F 17/27; G06N 99/00

(52) U.S. Cl. CPC G06N 5/02; G06N 99/005; G06F 17/2705

(57) ABSTRACT

An apparatus is described herein. The apparatus includes a clustering mechanism that is to partition a dictionary into a plurality of clusters. The apparatus also includes a feature-matching mechanism that is to pre-compute feature matching results for each cluster of the plurality of clusters. Moreover, the apparatus includes a selector that is to locate a best representative feature from the dictionary in response to an input vector.

### BACKGROUND ART

Machine learning includes algorithms that can learn from and make predictions on data. In machine learning, the tasks of learning and recognition are often preceded by a feature-matching operation. An array of features is usually stored as a matrix, and can be referred to as a dictionary. Inputs may be in the form of vectors, and the matching operation is performed by multiplying the input-vector with the feature matrix. An algorithm called Matching Pursuit (MP), and its many variants, such as the Orthogonal Matching Pursuit (OMP) can be used to determine the best combination of feature vectors to describe a given input signal.

### BRIEF DESCRIPTION OF THE DRAWINGS

FIG. 1 is a block diagram of an electronic device that enables the reconstruction of signals using a Gramian matrix;

FIG. 2 is process flow diagram of a method for machine learning;

FIG. 3 is a process flow diagram of a method for feature matching;

FIG. 4 is a conceptual view of a high dimensional sphere of dictionary atoms;

FIG. 5 is an illustration of a set of clusters where a matching pursuit algorithm is applied; and

FIG. 6 is a block diagram showing a medium that contains logic for reconstruction of image signals via GMT.

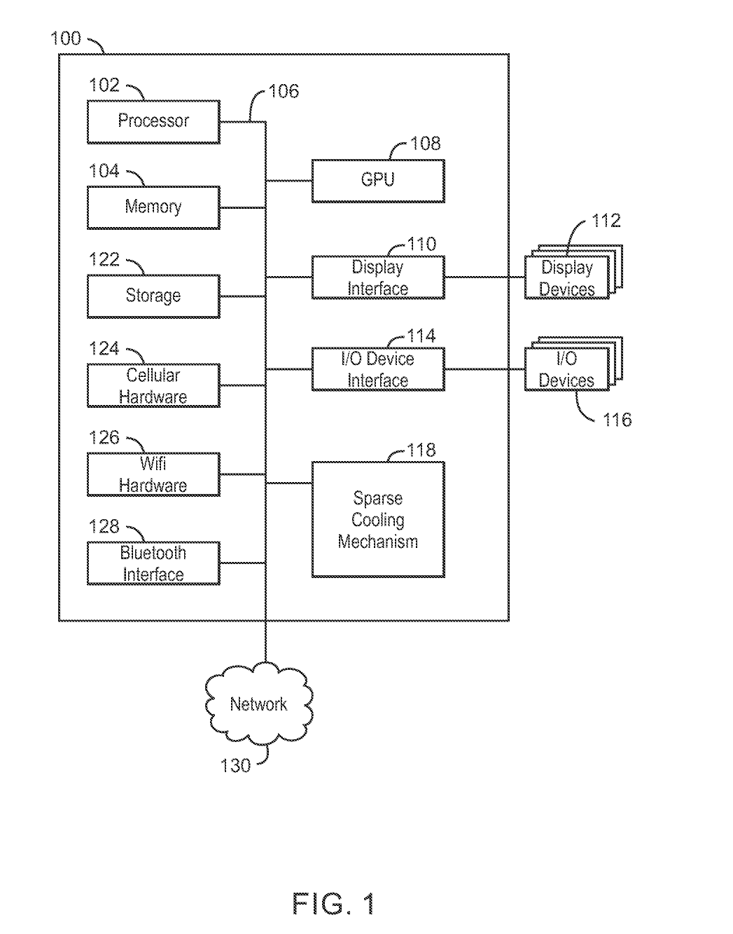

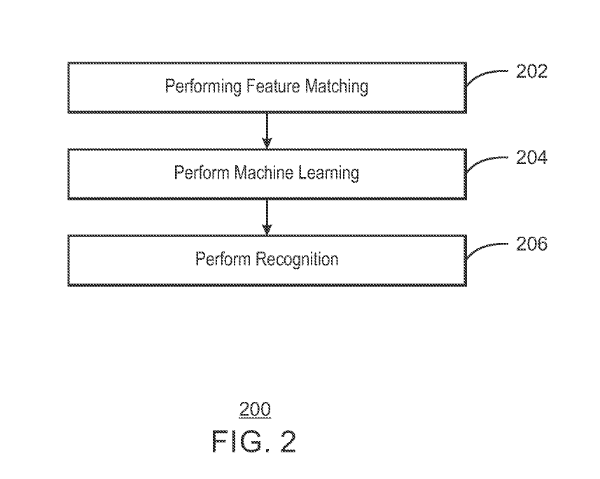

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Feature-matching may be used in sparse coding in order to provide a representation of input vectors as a weight linear combination of basis vectors. The basis vectors may be used to capture patterns in the input data. The basis vectors may be found in a dictionary and organized as a feature matrix, and the matching operation can be performed by multiplying the input-vector with the feature matrix. When the input vectors are very high-dimensional, and the feature matrix is very large, the multiplication step may consume a relatively large amount of time, which prevents real-time operations. Moreover, these vectors, and matrices all involve floating point operations that further worsens the situation by increasing the time it takes to complete the necessary computations. As a result, reconstruction of signals encoded using the sparse-coding techniques can take a large amount of time. In particular, the amount of time used for various calculations can prevent real-time implementation in hardware or software.

Embodiments described herein enable the reconstruction of features via a Gramian matrix. In embodiments, a clustering mechanism may partition a dictionary into a plurality of clusters. The feature matching results may be pre-computed for each cluster of the plurality of clusters. A best representative feature from the dictionary may be located via a matching pursuit algorithm in response to an input vector. In this manner, the number of multiplication operations is reduced significantly, enabling faster execution of feature matching, and ultimately faster execution of sparse coding techniques. The present techniques apply the clustering that occurs in the dictionary with an algebraic step in order to enable real-time operations, which results in an increase in speed of over two times compared to traditional feature-matching techniques.

FIG. 1 is a block diagram of an electronic device that enables the reconstruction of signals using a Gramian matrix. The electronic device 100 may be, for example, a laptop computer, tablet computer, mobile phone, smart phone, or a wearable device, among others. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, or the like, to be displayed to a user of the electronic device 100. In some embodiments, the GPU 108 includes a number of graphics engines, wherein each graphics engine is configured to perform specific graphics tasks, or to execute specific types of workloads.

The CPU 102 can be linked through the bus 106 to a display interface 110 configured to connect the electronic device 100 to a display device 122. The display device 122 can include a display screen that is a built-in component of the electronic device 100. The display device 122 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100.

Accordingly, the electronic device 100 also includes a sparse coding mechanism 118 to enable the representation of data in a concise manner. Sparse coding can be used to find high level features in a set of data. In some embodiments, data, such as an input vector, can be expressed as a combination of a feature matrix multiplied by a sparse representation of the input vector. In compressed sensing, the sparse representation of the input vector can be recovered, assuming that the feature matrix is known. The calculations associated with compressed sensing and sparse coding can be time consuming, especially considering the input vectors are typically high dimensional data. In embodiments, high dimensional data are data characterized by few dozen to many thousands of dimensions. For example, data associated with the JPEG, MPEG, and MP3 standards can be considered high dimensional data. In order to reduce the time spent waiting for these calculations to complete, some input data calculations can be pre-computed. The sparse representations that are pre-computed are discovered by virtue of the tendency of input data to form clusters, as described below.

The computing device also includes a storage device 122 that is a physical memory such as a hard drive, an optical drive, a flash drive, an array of drives, or any combinations thereof. The storage device 122 can store user data, such as audio files, video files, audio/video files, and picture files, among others. The storage device 122 can also store programming code such as device drivers, software applications, operating systems, and the like. The programming code stored to the storage device 122 may be executed by the CPU 102, GPU 108, or any other processors that may be included in the electronic device 100.

The CPU 102 may be linked through the bus 106 to cellular hardware 124. The cellular hardware 124 may be any cellular technology, for example, the 4G standard (International Mobile Telecommunications-Advanced (IMT-Advanced) Standard promulgated by the International Telecommunications Union-Radio communication Sector (ITU-R)). In this manner, the PC 100 may access any network 126 without being tethered or paired to another device, where the network 130 is a cellular network.

The CPU 102 may also be linked through the bus 106 to WiFi hardware 126. The WiFi hardware is hardware according to WiFi standards (standards promulgated as Institute of Electrical and Electronics Engineers' (IEEE) 802.11 standards). The WiFi hardware 126 enables the wearable electronic device 100 to connect to the Internet using the Transmission Control Protocol and the Internet Protocol (TCP/IP), where the network 130 is the Internet. Accordingly, the wearable electronic device 100 can enable end-to-end connectivity with the Internet by addressing, routing, transmitting, and receiving data according to the TCP/IP protocol without the use of another device. Additionally, a Bluetooth Interface 128 may be coupled to the CPU 102 through the bus 106. The Bluetooth Interface 128 is an interface according to Bluetooth networks (based on the Bluetooth standard promulgated by the Bluetooth Special Interest Group). The Bluetooth Interface 128 enables the wearable electronic device 100 to be paired with other Bluetooth enabled devices through a personal area network (PAN). Accordingly, the network 130 may be a PAN. Examples of Bluetooth enabled devices include a laptop computer, desktop computer, ultrabook, tablet computer, mobile device, or server, among others.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

In embodiments, compressive sensing may be used to sample signals. In compressive sensing, a signal may be sampled and compressed at a low sampling rate. Signals may be reconstructed with prior knowledge that the signal is sparse or compressible. Compressive sensing can be used to compress data related to a machine learning problem in a particular domain, such that solving the problem on the measurements will yield the solution of original problem. In other words, compressive sensing finds a compressed representation of the high dimensional data with minimal distortion of the signal. By enabling machine learning with a compressed domain, the number of samples taken can be scaled according to resource costs.

Inputs to a compressive sensing system are vectors, and the feature matching operation is performed by multiplying the input-vector with the feature matrix or dictionary. A signal is called sparse if it can be represented by a few components that are non-zero and the remaining components are zero. Such a signal can be sparsely approximated. Input vectors may be very large, and/or high dimensional. For example, a high dimensional input vector may include a pixel of an image. In such a scenario, the size of the image may cause each pixel to be large, resulting in a high dimensional input vector. Here, pixels are used for ease of description only. The present techniques may apply to any sort of signal processing.

FIG. 2 is process flow diagram of a method 200 for machine learning. At block 202, feature matching is performed. In machine learning, feature matching is often performed prior to a learning and recognition task. Feature matching compares detected features and notes their similarities. At block 204, after feature matching, the machine can then proceed to learning such that given an input data set regarding a particular domain, the machine can provide accurate information regarding the domain. At block 206, recognition occurs. As the machine proceeds with learning, the machine is able to recognize members of the domain.

Feature matching enables a machine to be trained using features where the resulting match of the feature is known. A component of a subspace can be represented by a potentially infinite number of features. While there is no universal definition of a feature, a feature may be determined based on the particular domain, problem, or the type of application applied to the machine learning. For example, in image processing, a feature may be defined as an “interesting” part of an image, and features are used as a starting point for many computer vision algorithms. In audio applications, a feature might be a particular frequency range of the audio signals. While particular features are described here, these features are for exemplary purposes only and the features described herein are not limited to the particular examples.

The feature matching operation is frequently performed by multiplying each input vector with the dictionary or feature matrix. However, when the input vectors are very high-dimensional, and the feature matrix is very large, the multiplication step takes too long, preventing real-time operations. Moreover, these vectors, and matrices all involve floating point operations that can add to the time needed to complete the calculations. However, the present techniques enable real time operations by pre-computing the calculations involved in feature matching.

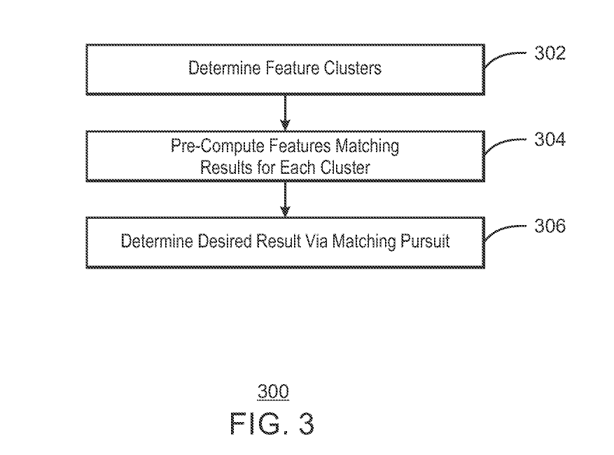

FIG. 3 is a process flow diagram of a method 300 for feature matching. At block 302, the feature clusters are determined. Typically, the features in a dictionary are not uniformly spread out over a high dimensional sphere. Instead, the features tend to cluster in areas along the sphere. Thus, the dictionary can be partitioned into clusters. In examples, the clustering may be performed by in an unsupervised fashion using k-means clustering. Additionally, dictionary clustering may be performed via hierarchical clustering, in which the features are clustered for a hierarchical traversal.

At block 304, future results of feature matching may be pre-computed. As noted above, the feature matching operation is frequently performed by multiplying each input vectors with the dictionary or feature matrix. In embodiments, future results of feature matching may be pre-computed using a Gramian matrix (Gram-matrix). Specifically, what is known a Gram-matrix trick (GMT), can be used to effectively pre-compute future results, thereby reducing repeated matrix multiplication of the cluster-matrices.

The use of the Gram matrix results in a less computationally intensive operation that can pre-compute the feature matching for a plurality of input vectors. The GMT reduces the number of multiplication operations to obtain the right cluster, resulting in saving a significant number of floating-point multiplication operations. In general, pre-computing based on the GMT of the cluster-centroid matrix may yield a sequence of clusters (for explaining the successive residuals) that may not be in sync with the sequence of vectors yielded by the GM pre-computation of the actual dictionary matrix. In other words, the sequence of atoms so obtained in the second case may not belong to the corresponding clusters yielded by the GMT-based matching pursuit on the cluster matrix.

However, when the clusters are physically relatively large, the GMT can be applied on the cluster-centroid matrix itself, and the resulting sequence will stay in sync with the actual sequence that would have been obtained had the original dictionary been used for feature-matching. Since the size of the cluster-centroid matrix is much smaller, the number of multiplications performed can be reduced. Thus, combining the GMT with large clusters can result in much improved performance of a matching-pursuit algorithm.

At block 306, a desired result can be determined via matching pursuit. When an input vector is provided, matching pursuit enables the pre-computed result to be located. In embodiments, matching pursuit is a sparse approximation that locates the best matching projection of the high dimensional data onto an over-complete dictionary. Matching pursuit locates an atom of the dictionary that has the largest inner product with the input vector, subtracts the contribution due to that atom, and the repeats this process until the input vector is satisfactorily decomposed.

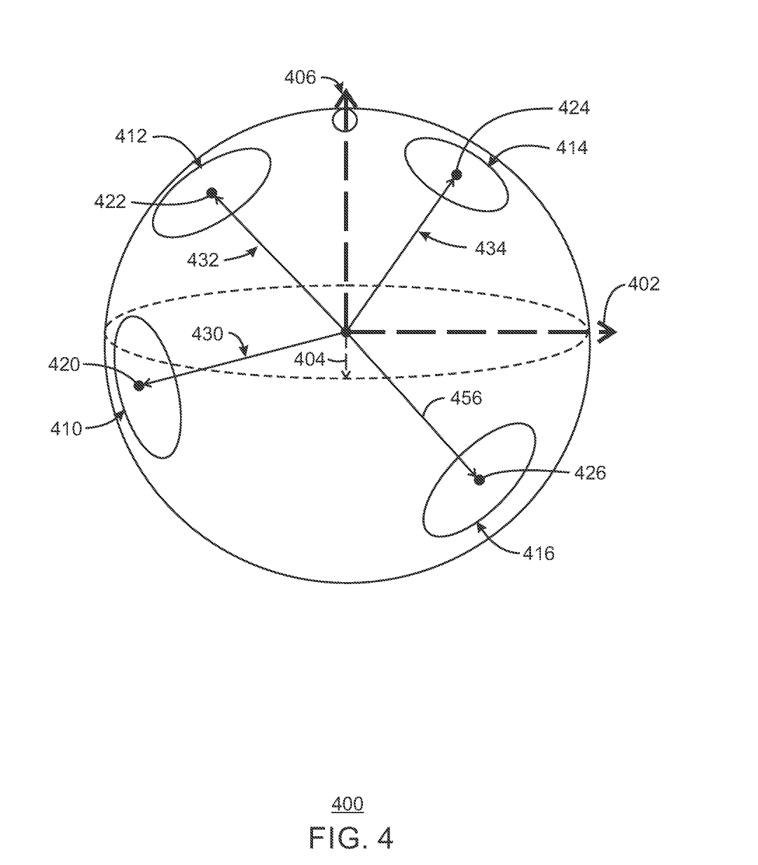

FIG. 4 is a conceptual view of a high dimensional sphere 400 of dictionary atoms. As used herein, a dictionary atom is a feature of the domain. The sphere is centered on an x-axis 402, a y-axis 404, and a z-axis 406. Each axis is normalized such that the sphere 400 is a unit sphere. Typically, the dictionary atoms occur in clusters. Thus, the sphere 400 is illustrated with clusters 410, 412, 414, and 416. Each cluster has a centroid 420, 422, 424, and 426, respectively. Each cluster represents a region where the feature-vectors of the dictionary generally cluster over the unit sphere. The centroid vectors 430, 432, 434, and 436 are collected into a new matrix C. A matching pursuit (MP) algorithm can be executed over this cluster-centroid matrix C.

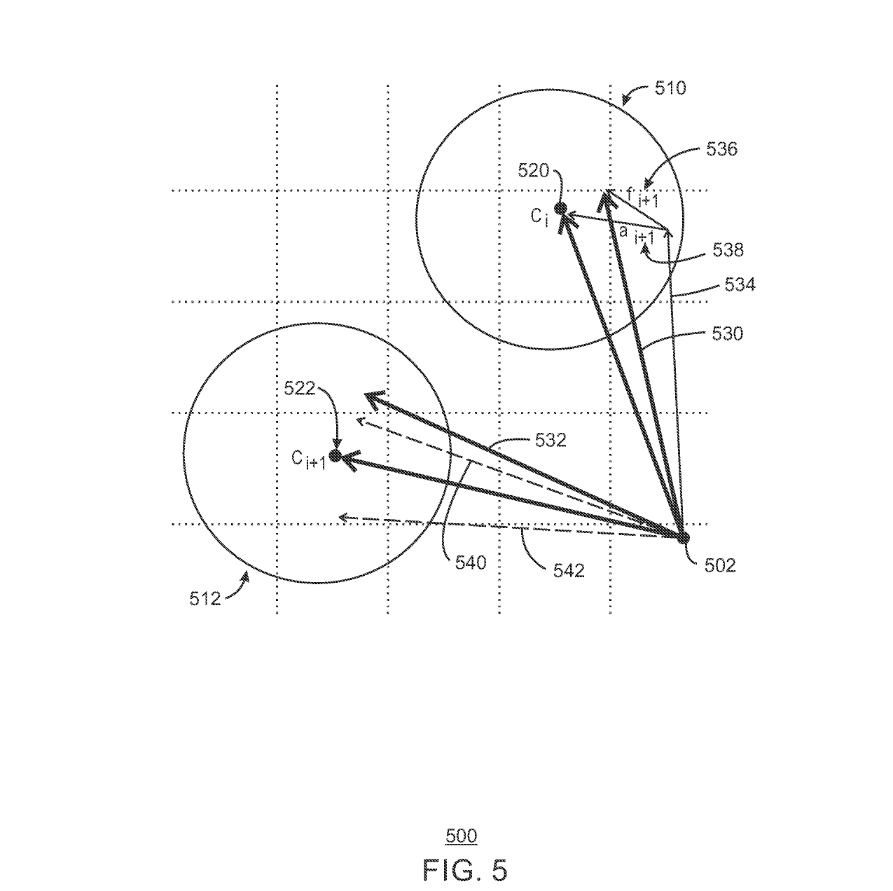

FIG. 5 is an illustration of a set of clusters 500 where a matching pursuit algorithm is applied. The set of clusters 500 includes a cluster 510 and a cluster 512. The cluster 510 includes a centroid Ci 520, and the cluster 512 includes a centroid Ci 522. In embodiments, the columns of the Ci of the new matrix, represents a cluster of feature, and the matching pursuit is run over this to select the best candidate cluster. Thus, when an input vector is obtained, the matching pursuit can be used to select the best candidate cluster. For each input vector at every iteration(i), the best representative feature (one cluster centroid) is selected, and then the real best feature is retrieved from the dictionary, where the search is located only on the selected cluster.

Consider the centroid matrix C as a dictionary. A sequence of matching pursuit iterations may be performed over the columns of the matrix C. At each iteration, the actual cluster residual fᵢ will determine the next cluster selected. If each cluster spans a sufficiently large area of the unit sphere, then there is a high chance that the actual residual fᵢ₊₁ and the cluster residual aᵢ₊₁ will both end up pointing to the same cluster. In this manner, the product of the centroid matrix and the input vectors is computed a single time, and the GMT is subsequently used to compute the next cluster residuals aᵢ₊₁. In embodiments, the residuals may represent the computation results located in each cluster.

For example, consider a unit sphere with a center 502 and clusters 510 and 512. The vector 530 represents a dictionary atom of the cluster 510, and the vector 532 represents a dictionary atom of the cluster 512. An input vector 534, is input into feature matching as described herein. The multiplication C^{T}X has been computed a single time, and represents the input vector X multiplied by the feature matrix C^{T}. Accordingly, when the input vector/residual 534 is input, the cluster residual 538 (which becomes 542 after normalization) indicates the next cluster to be selected according to a matching pursuit algorithm. The actual residual 536 represents the direction of the next feature vector to be selected based on the input vector, while the residual based on the cluster 538 represents the residual from the currently selected cluster. According to the present techniques, the actual residual 536 and the residual based on the cluster 538 can be used to guide the matching pursuit algorithm to the same cluster Cᵢ₊₁ in the next iteration. Since the actual residual normalized 540 and the cluster residual normalized 542 belong to the same cluster 522, the matching pursuit algorithm has succeeded in finding the correct result of C^{T}X for the input vector 534 within the cluster 522. It is important to note that the vectors 540 and 542 are likely to belong to the same cluster 522 (as long as the cluster-size is reasonably big, this is expected). This property of the algorithm keeps the GMT-based matching pursuit on the cluster-matrix in sync with the GMT-based matching pursuit on the original dictionary (much larger size).

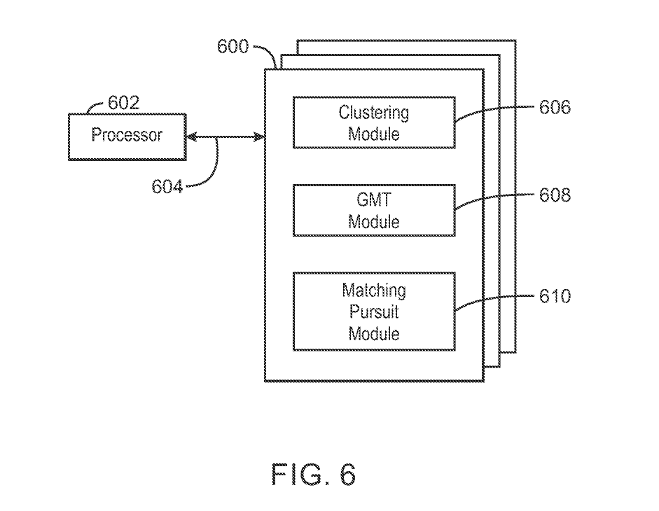

FIG. 6 is a block diagram showing a medium 600 that contains logic for reconstruction of image signals via GMT. The medium 600 may be a computer-readable medium, including a non-transitory medium that stores code that can be accessed by a processor 602 over a computer bus 604. For example, the computer-readable medium 600 can be volatile or non-volatile data storage device. The medium 600 can also be a logic unit, such as an Application Specific Integrated Circuit (ASIC), a Field Programmable Gate Array (FPGA), or an arrangement of logic gates implemented in one or more integrated circuits, for example.

The medium 600 may include modules 606-612 configured to perform the techniques described herein. For example, a clustering module 606 may be configured to partition the dictionary into clusters. A GMT module 608 may be configured to pre-compute results of feature-matching. A matching pursuit module 610 may be configured to locate the correct pre-computed result given an input vector. In some embodiments, the modules 607-612 may be modules of computer code configured to direct the operations of the processor 602.

The block diagram of FIG. 6 is not intended to indicate that the medium 600 is to include all of the components shown in FIG. 6. Further, the medium 600 may include any number of additional components not shown in FIG. 6, depending on the details of the specific implementation.

Example 1 is an apparatus. The apparatus includes a clustering mechanism that is to partition a dictionary into a plurality of clusters; a feature-matching mechanism that is to pre-compute feature matching results for each cluster of the plurality of clusters; and a selector that is to locate a best representative feature from the dictionary in response to an input vector.

Example 2 includes the apparatus of example 1, including or excluding optional features. In this example, the feature-matching mechanism is to pre-compute feature matching results using a Gram-matrix.

Example 3 includes the apparatus of any one of examples 1 to 2, including or excluding optional features. In this example, the feature-matching mechanism is to pre-compute feature matching results using a Gram-matrix trick.

Example 4 includes the apparatus of any one of examples 1 to 3, including or excluding optional features. In this example, the selector is to locate a best representative feature from the dictionary in response to an input vector via a matching pursuit algorithm.

Example 5 includes the apparatus of any one of examples 1 to 4, including or excluding optional features. In this example, the clustering mechanism is to partition the dictionary into a plurality of clusters for a hierarchical traversal.

Example 6 includes the apparatus of any one of examples 1 to 5, including or excluding optional features. In this example, each cluster of the plurality of clusters is substantially large such that a resulting feature matching vector remains synchronized with GMT-based matching pursuit on an original dictionary.

Example 7 includes the apparatus of any one of examples 1 to 6, including or excluding optional features. In this example, the selector that is to locate the best representative feature from the dictionary in an iterative fashion by using cluster residuals to determine the next cluster to be selected until the best representative feature is found. Optionally, the cluster residuals are computed using a Gram-matrix based pre-computation.

Example 8 includes the apparatus of any one of examples 1 to 7, including or excluding optional features. In this example, the best representative feature is a feature vector.

Example 9 includes the apparatus of any one of examples 1 to 8, including or excluding optional features. In this example, pre-computing feature matching results gives an increase of at least two times when compare to traditional feature matching.

Example 10 is a method. The method includes partitioning a dictionary into a plurality of clusters; pre-computing feature matching results for each cluster of the plurality of clusters; and locating a best representative feature from the dictionary in response to an input vector.

Example 11 includes the method of example 10, including or excluding optional features. In this example, pre-computing feature matching results for each cluster of the plurality of clusters is performed using a Gram-matrix.

Example 12 includes the method of any one of examples 10 to 11, including or excluding optional features. In this example, pre-computing feature matching results for each cluster of the plurality of clusters is performed using a Gram-matrix trick.

Example 13 includes the method of any one of examples 10 to 12, including or excluding optional features. In this example, locating a best representative feature from the dictionary in response to an input vector is performed using a matching pursuit algorithm.

Example 14 includes the method of any one of examples 10 to 13, including or excluding optional features. In this example, the dictionary is partitioned into a plurality of clusters for a hierarchical traversal.

Example 15 includes the method of any one of examples 10 to 14, including or excluding optional features. In this example, each cluster of the plurality of clusters is substantially large such that a resulting feature matching vector remains synchronized with GMT-based matching pursuit on an original dictionary.

Example 16 includes the method of any one of examples 10 to 15, including or excluding optional features. In this example, the best representative feature from the dictionary is located in an iterative fashion by using cluster residuals to determine the next cluster to be selected until the best representative feature is found. Optionally, the cluster residuals are computed using a Gram-matrix based pre-computation.

Example 17 includes the method of any one of examples 10 to 16, including or excluding optional features. In this example, the best representative feature is a feature vector.

Example 18 includes the method of any one of examples 10 to 17, including or excluding optional features. In this example, pre-computing feature matching results gives an increase of at least two times when compare to traditional feature matching.

Example 19 is a tangible, non-transitory, computer-readable medium. The computer-readable medium includes instructions that direct the processor to partition a dictionary into a plurality of clusters; pre-compute feature matching results for each cluster of the plurality of clusters; and locate a best representative feature from the dictionary in response to an input vector.

Example 20 includes the computer-readable medium of example 19, including or excluding optional features. In this example, pre-computing feature matching results for each cluster of the plurality of clusters is performed using a Gram-matrix.

Example 21 includes the computer-readable medium of any one of examples 19 to 20, including or excluding optional features. In this example, pre-computing feature matching results for each cluster of the plurality of clusters is performed using a Gram-matrix trick.

Example 22 includes the computer-readable medium of any one of examples 19 to 21, including or excluding optional features. In this example, locating a best representative feature from the dictionary in response to an input vector is performed using a matching pursuit algorithm.

Example 23 includes the computer-readable medium of any one of examples 19 to 22, including or excluding optional features. In this example, the dictionary is partitioned into a plurality of clusters for a hierarchical traversal.

Example 24 includes the computer-readable medium of any one of examples 19 to 23, including or excluding optional features. In this example, each cluster of the plurality of clusters is substantially large such that a resulting feature matching vector remains synchronized.

Example 25 includes the computer-readable medium of any one of examples 19 to 24, including or excluding optional features. In this example, the best representative feature from the dictionary is located in an iterative fashion by using cluster residuals to determine the next cluster to be selected until the best representative feature is found. Optionally, the cluster residuals are computed using a Gram-matrix trick.

Example 26 includes the computer-readable medium of any one of examples 19 to 25, including or excluding optional features. In this example, the best representative feature is a feature vector.

Example 27 includes the computer-readable medium of any one of examples 19 to 26, including or excluding optional features. In this example, pre-computing feature matching results gives an increase of at least two times when compare to traditional feature matching.

Example 28 is a system. The system includes instructions that direct the processor to a display; an image capture mechanism; a memory that is to store instructions and that is communicatively coupled to the image capture mechanism and the display; and a processor communicatively coupled to the image capture mechanism, the display, and the memory, wherein when the processor is to execute the instructions, the processor is to: partition a dictionary into a plurality of clusters; pre-compute feature matching results for each cluster of the plurality of clusters; and locate a best representative feature from the dictionary in response to an input vector.

Example 29 includes the system of example 28, including or excluding optional features. In this example, the feature-matching mechanism that is to pre-compute feature matching results using a Gram-matrix.

Example 30 includes the system of any one of examples 28 to 29, including or excluding optional features. In this example, the feature-matching mechanism that is to pre-compute feature matching results using a Gram-matrix trick.

Example 31 includes the system of any one of examples 28 to 30, including or excluding optional features. In this example, the selector is to locate a best representative feature from the dictionary in response to an input vector via a matching pursuit algorithm.

Example 32 includes the system of any one of examples 28 to 31, including or excluding optional features. In this example, the clustering mechanism is to partition the dictionary into a plurality of clusters for a hierarchical traversal.

Example 33 includes the system of any one of examples 28 to 32, including or excluding optional features. In this example, each cluster of the plurality of clusters is substantially large such that a resulting feature matching vector remains synchronized with GMT-based matching pursuit on an original dictionary.

Example 34 includes the system of any one of examples 28 to 33, including or excluding optional features. In this example, the selector that is to locate the best representative feature from the dictionary in an iterative fashion by using cluster residuals to determine the next cluster to be selected until the best representative feature is found.

Example 35 includes the system of any one of examples 28 to 34, including or excluding optional features. In this example, the cluster residuals are computed using a Gram-matrix based pre-computation.

Example 36 includes the system of any one of examples 28 to 35, including or excluding optional features. In this example, the best representative feature is a feature vector.

Example 37 includes the system of any one of examples 28 to 36, including or excluding optional features. In this example, pre-computing feature matching results gives an increase of at least two times when compare to traditional feature matching.

Example 38 is an apparatus. The apparatus includes instructions that direct the processor to a clustering mechanism that is to partition a dictionary into a plurality of clusters; a means to pre-compute feature matching results for each cluster of the plurality of clusters; and a selector that is to locate a best representative feature from the dictionary in response to an input vector.

Example 39 includes the apparatus of example 38, including or excluding optional features. In this example, the means to pre-compute feature matching results is to pre-compute feature matching results using a Gram-matrix.

Example 40 includes the apparatus of any one of examples 38 to 39, including or excluding optional features. In this example, the means to pre-compute feature matching results is to pre-compute feature matching results using a Gram-matrix trick.

Example 41 includes the apparatus of any one of examples 38 to 40, including or excluding optional features. In this example, the selector is to locate a best representative feature from the dictionary in response to an input vector via a matching pursuit algorithm.

Example 42 includes the apparatus of any one of examples 38 to 41, including or excluding optional features. In this example, the clustering mechanism is to partition the dictionary into a plurality of clusters for a hierarchical traversal.

Example 43 includes the apparatus of any one of examples 38 to 42, including or excluding optional features. In this example, each cluster of the plurality of clusters is substantially large such that a resulting feature matching vector remains synchronized with GMT-based matching pursuit on an original dictionary.

Example 44 includes the apparatus of any one of examples 38 to 43, including or excluding optional features. In this example, the selector that is to locate the best representative feature from the dictionary in an iterative fashion by using cluster residuals to determine the next cluster to be selected until the best representative feature is found. Optionally, the cluster residuals are computed using a Gram-matrix based pre-computation.

Example 45 includes the apparatus of any one of examples 38 to 44, including or excluding optional features. In this example, the best representative feature is a feature vector.

Example 46 includes the apparatus of any one of examples 38 to 45, including or excluding optional features. In this example, the means to pre-compute feature matching results gives an increase of at least two times when compare to traditional feature matching.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus, comprising:
a clustering mechanism that is to partition a dictionary into a plurality of clusters;
a feature-matching mechanism that is to pre-compute feature matching results for each cluster of the plurality of clusters; and
a selector that is to locate a best representative feature from the dictionary in response to an input vector.

2. The apparatus of claim 1, wherein the feature-matching mechanism is to pre-compute feature matching results using a Gram-matrix.

3. The apparatus of claim 1, wherein the feature-matching mechanism is to pre-compute feature matching results using a Gram-matrix trick.

4. The apparatus of claim 1, wherein the selector is to locate a best representative feature from the dictionary in response to an input vector via a matching pursuit algorithm.

5. The apparatus of claim 1, wherein the clustering mechanism is to partition the dictionary into a plurality of clusters for a hierarchical traversal.

6. A method, comprising:
partitioning a dictionary into a plurality of clusters;
pre-computing feature matching results for each cluster of the plurality of clusters; and
locating a best representative feature from the dictionary in response to an input vector.

7. The method of claim 6, wherein pre-computing feature matching results for each cluster of the plurality of clusters is performed using a Gram-matrix.

8. The method of claim 6, wherein pre-computing feature matching results for each cluster of the plurality of clusters is performed using a Gram-matrix trick.

9. The method of claim 6, wherein locating a best representative feature from the dictionary in response to an input vector is performed using a matching pursuit algorithm.

10. The method of claim 6, wherein the dictionary is partitioned into a plurality of clusters for a hierarchical traversal.

11. The method of claim 6, wherein each cluster of the plurality of clusters is substantially large such that a resulting feature matching vector remains synchronized with GMT-based matching pursuit on an original dictionary.

12. The method of claim 6, wherein the best representative feature from the dictionary is located in an iterative fashion by using cluster residuals to determine the next cluster to be selected until the best representative feature is found.

13. The method of claim 12, wherein the cluster residuals are computed using a Gram-matrix based pre-computation.

14. The method of claim 6, wherein the best representative feature is a feature vector.

15. The method of claim 6, wherein pre-computing feature matching results gives an increase of at least two times when compare to traditional feature matching.

16. A tangible, non-transitory, computer-readable medium comprising instructions that, when executed by a processor, direct the processor to:
partition a dictionary into a plurality of clusters;
pre-compute feature matching results for each cluster of the plurality of clusters; and
locate a best representative feature from the dictionary in response to an input vector.

17. The computer readable medium of claim 16, wherein pre-computing feature matching results for each cluster of the plurality of clusters is performed using a Gram-matrix.

18. The computer readable medium of claim 16, wherein pre-computing feature matching results for each cluster of the plurality of clusters is performed using a Gram-matrix trick.

19. The computer readable medium of claim 16, wherein locating a best representative feature from the dictionary in response to an input vector is performed using a matching pursuit algorithm.

20. The computer readable medium of claim 16, wherein the dictionary is partitioned into a plurality of clusters for a hierarchical traversal.

21. A system, comprising:
a display;
an image capture mechanism;
a memory that is to store instructions and that is communicatively coupled to the image capture mechanism and the display; and
a processor communicatively coupled to the image capture mechanism, the display, and the memory, wherein when the processor is to execute the instructions, the processor is to:
partition a dictionary into a plurality of clusters;
pre-compute feature matching results for each cluster of the plurality of clusters; and
locate a best representative feature from the dictionary in response to an input vector.

22. The system of claim 21, wherein the feature-matching mechanism that is to pre-compute feature matching results using a Gram-matrix.

23. The system of claim 21, wherein the feature-matching mechanism that is to pre-compute feature matching results using a Gram-matrix trick.

24. The system of claim 21, wherein the selector is to locate a best representative feature from the dictionary in response to an input vector via a matching pursuit algorithm.

25. The system of claim 21, wherein the clustering mechanism is to partition the dictionary into a plurality of clusters for a hierarchical traversal.
